(19) United States
(12) Patent Application Publication
(10) Pub. No.: US 2010/0202346 A1
(43) Pub. Date: Aug. 12, 2010

(54) WIRELESS COMMUNICATION SYSTEM AND METHOD

(76) Inventors: Ryan Z. Sitzes, Jackson, MO (US); Mohammed M. Al-Bathal, Kuwait City (KW)

Correspondence Address: MEYERTONS, HOOD, KIVLIN, KOWERT & GOETZEL, P.C., P.O. BOX 398, AUSTIN, TX, 78767-0398, US

(21) Appl. No.: 12/370,218

(22) Filed: Feb. 12, 2009

(51) Int. Cl. H04W 40/00

(52) U.S. Cl. 370/328

(57) ABSTRACT

Provided in some embodiments is a method of wireless inter-vehicle communication. The method includes storing a message packet in a shared memory location of a first communication device. The shared memory location is wirelessly accessible by one or more other communication devices. The method also includes assessing, at a second communication device, whether or not the message packet stored in the shared memory location of the first communication device is intended to be received at the second communication device and assessing, at the second communication device, whether or not to accept the message packet from the shared memory location of the first communication device. Further, the method includes receiving at least a portion of the message packet at the second communication device if it is determined that the message packet should be accepted from the shared memory location of the first communication device.

### BACKGROUND

1. Field of the Invention

The present invention generally relates to systems and methods for wireless communication and more particularly to wireless vehicle-to-vehicle communication.

2. Description of Related Art

Wireless forms of communication have become more prevalent in society over the past decade. These forms of communication include cellular telephones, satellite communications, short-range data transfer and the like. For example, Internet/wireless access points and devices are increasingly prevalent in offices, commercial businesses, and homes. Further, wireless forms of communication are provided by in blanket form by wireless service providers.

Previously viewed as a luxury, dependency on wireless communication has transformed into an efficient and desired communication between persons and devices. For example, cellular telephones are often used to send and receive information relating to an emergency, relay short textual messages, send electronic mail (e-mail) and the like. As persons have become more comfortable and dependent on wireless forms of communications there is an increasing desire that devices are extended into various locations in their everyday environment. This includes the integration of communication devices into a vehicle.

Vehicle communication systems may include those vehicle-to-vehicle (e.g., inter-vehicle) communication systems used to transmit information from a person or device in one vehicle to a person or device in another vehicle. Inter-vehicle communication may be particularly suited for sending messages warning of an impending traffic maneuver, apologizing to fellow drivers for a driving mistake, or social messaging. For instance, if a person were attempting to drive through a crowded intersection, it would be convenient to have a way to inform other drivers in the crowded intersection of their presence, to request drivers yield a right-of-way, or to say “thank you” to a courteous driver who yields a right-of-way. There may be cases when a driver of a vehicle wishes to ask a nearby driver for directions, ask another driver's intention when making a right or left turn at an intersection, or give a notice when entering an arterial highway, for example. Military convoys, tour groups and safari services comprised of multiple vehicles, corporate vehicle fleets, motorcycle enthusiasts, and the like may also benefit from a secure-wireless inter-vehicle communication system. Such a communication system could also be used to communicate with non-vehicle devices such as drive-through restaurant menu kiosks, automated bank teller machines, and the like. An inter-vehicle communication system could also enable advanced warnings of upcoming accidents or traffic irregularities due to emergencies and emergency vehicles. Other applications and advantages of inter-vehicle communication may be recognized, including, among others, collision avoidance, toll collection, intelligent highway systems, traffic control, and automated vehicle control.

Although certain vehicle communication systems have been contemplated, certain concerns still exist. For example, data communication may not be secure thereby allowing messages to be transmitted or accessed without permission, placing users at risk of receiving unwanted messages, enabling data on the devices to be corrupted by a computer virus, or the like. Traditional forms of wireless communication often require an access fee. For example, a subscription to a wireless service provider to transmit messages to specific devices over long-distances is usually associated with a monthly fee for use of services that is undesirable for many users. Wireless communication networks often include a central location, such as a server, that acts as a common link between users to facilitate the transmission of data from one user to another. The addition of central servers can complicate the transmission of data thereby further increasing the associated cost. In the case a wireless service provider is not required, applications generally utilize high-cost, high-power Radio Frequency (RF) transceivers to transmit data. These systems are generally difficult to integrate inexpensively with compact and portable electronic devices such as Personal Digital Assistants (PDAs) and laptop computers. Further, certain types of transmission (e.g., infrared transmission) require an unobstructed line-of-sight, which may be impossible in many cases. In the case of short-range communication, the relatively close proximity of devices may cause interference unless a frequency-hopping or similar method is employed. Information transferred by conventional unencrypted radio frequency transmission is potentially available to anyone who wishes to “listen” on the same radio frequency or is able to bypass functions intended to isolate transmission between a number of selected devices. Further, forms of wireless communication are typically limited to known senders and known receivers (e.g., those devices that can provide verification or user authentication to one another). In other words, a person typically needs to know certain verification or authentication information such as a passkey, password, number, or the like of the person they are attempting to contact. This can be difficult in the event a user desires to communicate wirelessly with any number of parties owning a number of certain devices, hereinafter referred to as “unknown” devices, where information required to establish communication is not universally available or possible to obtain a priori (i.e., without prior knowledge or experience). These factors can lead to a decreased confidence in wireless transmission security, increase the relative cost of wireless communication, and reduce the overall usability of the wireless system.

It is thus desirable that a communication system provides a secure and affordable form of wireless communication. It is further desirable that such a communication system be made available for communication between vehicle occupants and/or devices.

### SUMMARY

Various embodiments of communication systems and related apparatus, and methods of operating the same are described. In one embodiment, included is a method of wireless inter-vehicle communication. The method includes storing a message packet in a shared memory location of a first communication device. The shared memory location is wirelessly accessible by one or more other communication devices. The method also includes assessing, at a second communication device, whether or not the message packet stored in the shared memory location of the first communication device is intended to be received at the second communication device and assessing, at the second communication device, whether or not to accept the message packet from the shared memory location of the first communication device. Further, the method includes receiving at least a portion of the message packet at the second communication device if it is determined that the message packet should be accepted from the shared memory location of the first communication device.

In another embodiment, a method of wireless inter-vehicle communication includes generating, at a first communication device in a first vehicle, a message packet comprising a message and a label indicative of an intended recipient and storing the message packet in a shared memory location of the first communication device such that at least the label indicative of the intended recipient is accessible by one or more other communication devices. The method also includes assessing, at a second communication device in a second vehicle associated with the intended recipient, whether at least a portion of the message packet comprising the label is intended for delivery to at least the second communication device associated with the intended recipient and assessing, at the second communication device, based at least in part on the label whether at least a portion of the message packet comprising the label is intended for delivery to at least the second communication device associated with the intended recipient, as well as assessing, at the second communication device associated with the intended recipient, whether or not to receive the message packet. Further, the method includes receiving, at the second communication device associated with the intended recipient, at least the message of the message packet.

In yet another embodiment, provided is an inter-vehicle communication device that includes a vehicle communication device locatable in a vehicle. The vehicle communication device includes an identification memory location comprising a unique identifier associated with the vehicle, such as a license plate number, a shared memory location accessible by other communication devices on an inter-vehicle communication network, and a wireless communication device that can be used to exchange data directly with one or more other vehicle communication devices on the inter-vehicle communication network.

In yet another embodiment, provided is an inter-vehicle communication system that includes an inter-vehicle communication network. The inter-vehicle communication network includes a first vehicle communication device located in a first vehicle and at least one second vehicle communication device located in a second vehicle. The first vehicle communication device includes an identification memory location comprising a first unique identifier associated with the first vehicle and a shared memory location wirelessly accessible by one or more of the second communication devices on the inter-vehicle communication network.

### BRIEF DESCRIPTION OF THE DRAWINGS

Advantages of the present invention will become apparent to those skilled in the art with the benefit of the following detailed description and upon reference to the accompanying drawings in which:

FIGS. 1A-1B are graphical representations of an inter-vehicle network in accordance with one or more embodiments of the present technique.

FIG. 2 is a flowchart that illustrates a method for associating a communication device with a communication network in accordance with one or more embodiments of the present technique.

FIG. 3 is flowchart that illustrates a method of operation of a communication device in accordance with one or more embodiments of the present technique.

FIGS. 4A and 4B are flowcharts that illustrate methods of operating one or more communication devices in accordance with one or more embodiments of the present technique;

FIG. 5 is a block diagram that illustrates a communication device in accordance with one or more embodiments of the present technique.

FIG. 6 is a block diagram that illustrates functional units of a communication device in accordance with one or more embodiments of the present technique.

FIG. 7 is a block diagram that illustrates the integration of a Bluetooth transceiver in accordance with one embodiment of the present technique.

FIG. 8 is a block diagram that illustrates integration of an inter-vehicle communication program in accordance with one or more embodiments of the present technique.

FIG. 9 is a block diagram that illustrates organization of a number of functional units included in an inter-vehicle communication program and associated graphical user interface in accordance with one or more embodiments of the present technique.

FIGS. 10A-12D illustrates front and side views of the communication device in accordance with embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

As discussed in more detail below, certain embodiments of the present technique include a system and method for communication between occupants and/or devices of different vehicles, otherwise referred to herein as “inter-vehicle communication.” In some embodiments, an inter-vehicle communication system includes a plurality of vehicle communication devices configured to transmit data between one another. Certain embodiments may include registration of a vehicle communication device before it is activated and useable on an inter-vehicle communication network. Registration may include associating a license plate number, or similar identification feature, with the registered vehicle communication device. In certain embodiments, the transmission of data may be provided via direct communication between two of the communication devices, e.g., a source communication device and a destination communication device. The source device may include a communication device that is generating/sending a communication message. The destination device may include a communication device that is an intended recipient of the communication or message. In other embodiments, the transmission of data may be provided via an indirect communication between two or more communication devices, e.g., via an intermediate communication device that relays a communication signal between the source and destination devices in ad hoc fashion. The intermediate device may include a communication device substantially similar to the source and destination devices (e.g., another communication device that can also be used as a source and/or destination communication device) such that a dedicated central server is not required. Further, in certain embodiments, communication between the communication devices is secured such that only intended recipients can receive the communication upon their acceptance of the communication. In some embodiments, one communication device, e.g., the source communication device, may store a message in a shared location such that only the destination communication device intended to receive the communication can assess and determine that a message is available for its receipt. In some embodiments, the receiving device may prompt a user or otherwise determine whether or not to accept receipt of the message or to decline receipt of the message. Assessment of whether or not to retrieve the message may be based at least in part on an identification feature (e.g., the license plate number) associated with the source communication device. Further, certain embodiments of a communication device may include integration of programs including, but not limited to, navigation tools, personal organization systems, media players, internet utilities, and the like. Certain embodiments may include a communication device having a form factor that can be employed on the dash of a vehicle, integrated with an entertainment system of the vehicle, integrated into another feature of the vehicle (e.g., a rearview minor), or the like.

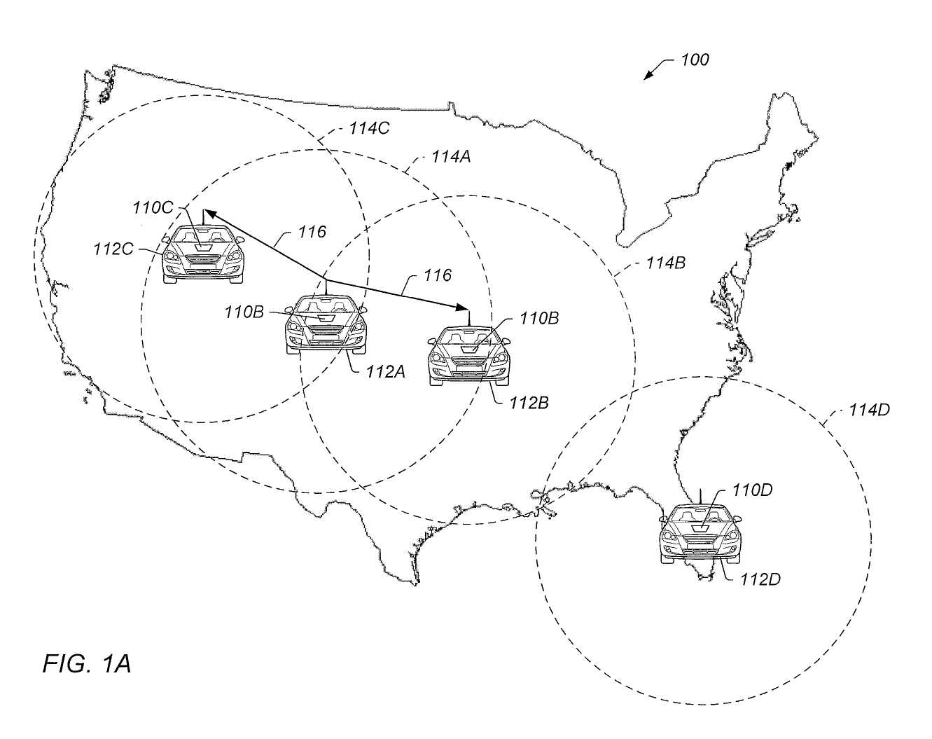

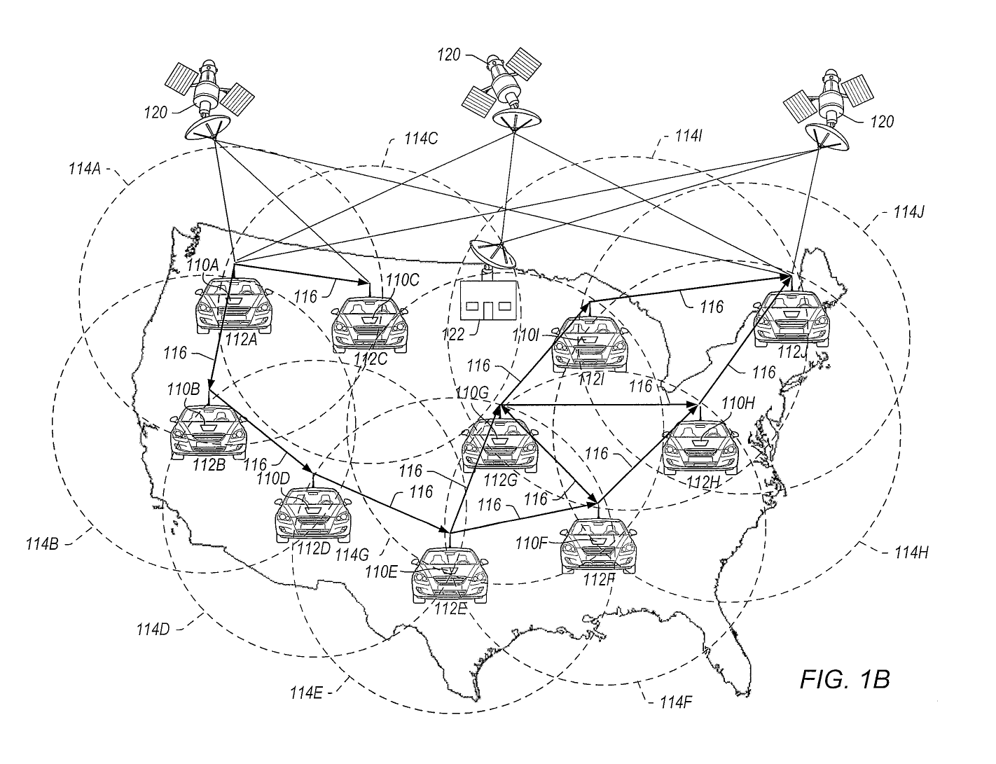

Turning now to FIG. 1A, depicted is a graphical representation of an inter-vehicle network 100 in accordance with certain embodiments of the present technique. The network 100 includes a plurality of inter-vehicle communication devices 110A, 110B, 110C and 110D (“communication devices 110”). Each of inter-vehicle communication devices 110 is located in vehicles 112A, 112B, 112C and 112D, respectively. Communication devices 110 may be configured to communicate wirelessly with one another. For instance, communication device 110A may be capable of sending and/or receiving wireless transmission that are received and/or sent by one or more of the other communication devices, such as communication devices 110B and 110C.

In some embodiments, wireless communication between the communication devices may be accomplished in accordance with an established data transmission protocol. For example, the communication devices may exchange data in accordance with a form of the Bluetooth standard, Shared Wireless Access Protocol (SWAP), and/or Shared Wireless Access Protocol-Cordless Access (SWAP-CA), discussed in more detail below. In some embodiment, suitable transceivers can be formed from relatively inexpensive complementary metal-oxide-semiconductor (CMOS) integrated chips that may connect to a device through a Universal Serial Bus (USB) interface, for example.

In certain embodiments, communication between two or more communication devices may occur within a transmission range of one or more of the communication devices or outside of a transmission range of one or more of the communication devices. The transmission range may be defined by a maximum physical distance the sending/receiving communication device can be separated by and still reliable communicate with one another. In other words, how far a signal and the resulting communication can reliably be transmitted from a sending communication device to a receiving communication device. The effective transmission range of a communication device can vary based on certain factors including the characteristics (e.g., the strength) of the generated signal, sensitivity of the receiving device, environmental conditions proximate the devices, and the like. FIG. 1A illustrates transmission ranges of communication devices 100. The transmission range of each of communication devices 110A, 110B, 110C and 110D is represented by regions 114A, 114B, 114C and 114D, respectively, defined by dashed lines. In the illustrated embodiment, the regions 114A, 114B, 114C and 114D include substantially circular areas and that are representative of a generally consistent transmission range in all directions. In practice, however, the transmission ranges may vary based on the factors discussed above. Further, the transmission range may be different from one device to another. In some embodiment, the transmission range may be physically limited by environmental factors, and in other embodiments the transmission range may be determined (e.g., in software). For example, the strength of the communication signal may be manipulated to increase or decrease the effective transmission range. In another embodiment, the transmission range may be dictated based on relative positions. For example, even though a communication device is capable of a transmission range of 1 mile, the system may limit receipt of the signal to devices within 0.5 mile. In one embodiment, limiting the effective transmission range may include comparing the location of each device (e.g., a GPS determined position) and blocking or otherwise preventing devices outside of the dictated transmission range from receiving the communication signal.

Operation of a communication device that limits communication to only to devices within its transmission range may be referred to as a “short-range” mode of operation. A short-range mode is described, where a source communication device (e.g., communication device 110A) communicates with any number of similar destination devices within the transmission range (e.g., “one hop”) of the source device. A communication signal may be broadcast only once, and may not be rebroadcast in ad-hoc fashion from devices serving as intermediate nodes to contact similar devices outside the source device's transmission range. A “hop” is used in this document as defined by exactly and only one broadcast of a communication signal between two similar devices within each other's transmission range. In “short-range” mode a first vehicle or non-vehicle having a communication device enables occupants thereof to send communication signals to a number of similar devices located similarly in other vehicles or non-vehicles within its transmission range. Similarly, occupants of the other vehicles or non-vehicles may respond or exchange communication signals to vehicle or non-vehicle, or any other number of vehicles or non-vehicles within one hop or their respective transmission ranges.

FIG. 1A illustrates transmission of communication signals between communication devices in sort-range mode. In the illustrated embodiment, communication device 110A is operates as a source communication device by transmitting a signal directed to and/or received at communication devices 110B and 110C, as represented by arrows 116. “Source” communication device may refer to a communication device generating or otherwise transmitting a communication signal that is used to transmit information, such as a message and/or message packet, described in more detail below. Communication devises 110B and 110C are within the transmission rage of communication device 110A as indicated by their location within region 114A. The communication signal, however, is not received at communication device 110D. Communication device 110D is not within the transmission range of source communication device 110A, as indicated by its location outside of the region 114A. In one embodiment, the source communication device may be employed to send a communication to a recipient within its transmission range. For example, one or both of communication devices 110B and 110C may be the intended recipients of the transmission (e.g., a message) from source communication device 110A. If communication devices 110B and/or 110C are the intended recipients of the communication, they may each be referred to as a “destination” communication device. Because the communication devices 110B and 110C are within the range of communication device 110A, they may receive the transmission signal directly from communication device 100A. In other words, the communication devices 100B and 110C receive the communication signal from the transmitting communication device 110A without any manipulation of the signal by other devices. Manipulation of the signal may include relay of the communication signal by another communication device (such as intermediate communication device described in more detail below), an intermediate server, a central server, a signal boosting/amplifying station, or the like.

Operation of a communication device that includes communication to devices outside of its transmission range may be referred to as a “long-range” mode of operation. A long-range mode is described where a source device communicates with any number of similar destinations communication devices within a number of hops outside of its transmission range.

FIG. 1B illustrates the transmission of communication signals between communication devices in long-range mode. The illustrated embodiment includes several communication devices located inside and outside the transmission range of source communication device 110A. In the illustrated embodiment, communication devices 110B and 110C are within the range of communication device 110A, and thus may receive the communication signal 116 directly from communication device 100A. Communication devices 110D-110J and respective vehicles 112D-110J are outside of transmission range 114A of communication device 110A. Accordingly, communication signal 116 can travel directly to communication devices 110B and 110C, but may not be received directly at communication devices 112D-110J. Where an intended recipient(s) (e.g., destination communication device) of the communication is outside of the transmission range of the source device, long-range mode may be employed to direct the communication signal to the intended recipient(s) in the extended transmission range (e.g., the range beyond the a normal transmission range of the source communication device). In an embodiment where communication device 110D is the intended recipient, the communication signal may be transmitted by one additional hop from communication device 110B. In other words, the communication signal 116 may be directed/relayed from source communication device 110A to intermediate communication device 110B and to destination communication device 110D. In one embodiment in which communication device 110J is the intended recipient, communication signal 116 may be transmitted by multiple hops (e.g., five hops) from communication device 110B. In other words, the communication signal 116 may be directed/relayed from source communication device 110A to intermediate communication device 110B and a combination of other intermediate communication devices 110D-1101 before being received at destination communication device 110J. Other embodiments may include any number of recipients and hops to direct/relay a communication signal to one or more intended recipient(s). Communication devices of the network 100 may also respond in a similar manner. For example, in one embodiment the destination communication device may receive the communication and may, then, take the role as a source communication device by directing a message to the original source communication device or another communication device now taking the role of the destination communication device. In other words, bi-directional communication is provided in a similar manner wherein each communication devices is capable of operating as a source, intermediate, and/or destination communication device. In other words, the communication devices are substantially similar such that they operate in a similar manner and are can thus be used to send, transmit, and/or receive communications (e.g., messages).

In one embodiment, one or more of the communication devices may receive detailed location information from GPS satellites 120, which are monitored by GPS monitoring station 122. The communication devices may also serve as nodes in a wireless mobile ad-hoc network comprised of vehicles and non-vehicles containing similar devices also GPS enabled and with similar transmission ranges. In the illustrated embodiment, occupants/devices of vehicle 112A that wish to send a packet of information to other vehicle occupants, may assess or determine the location resource of the other vehicles and route communication via the appropriate resource discovery and routing protocol. In certain embodiments, the GPS systems may aid in assessing and determine the appropriate routing for the communication signal. For example, the GPS enabled communication devices may assess the location of various vehicles and communication devices, and route the communication signals in the shortest path, the most reliable path, and/or a path based on some other assessment. As described, intermediate nodes forming the network may rebroadcast the communication signal in ad hoc fashion from the source node (vehicle or non-vehicle) to the destination node (vehicle or non-vehicle). Similarly, occupants of a vehicle or non-vehicle may respond or exchange communication signals to a vehicle or non-vehicle in a reverse fashion. Exact route used may vary as shown with the specific routing protocol employed.

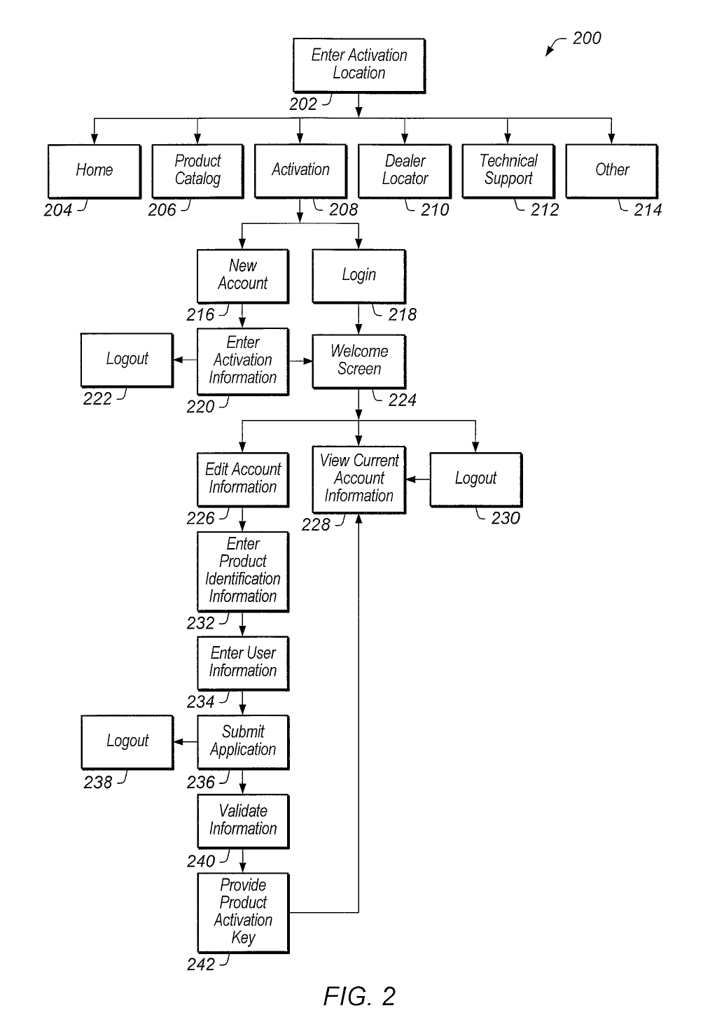

Turning now to FIG. 2, depicted is a flowchart that illustrates a method 200 for associating a communication device with a communication network, in accordance with embodiments of the present technique. In certain embodiments it may be desirable for a user to perform a combination of one or more forms of initialization, registration, or activation of each communication device that enables use of the respective communication device on a network (e.g., inter-vehicle communication network 100). Such a process may help to ensure that each communication device is authentic, that users are who they claim to be, and otherwise provide an accountability that helps to ensure safe and secure use of each communication device. In one embodiment, such a process may include associating a user's identity to a communication device as well as the communication device's identity to a license plate number to help ensure users are associated with the license plate number.

FIG. 2 illustrates one embodiment of an optional method that can be implemented in software for activating a communication device. The method may be employed as a user-vehicle registration function accessed through an online utility (e.g., an internet website). For example, upon purchasing a communication device, a user may activate the product via an online-registration system. In one embodiment, activation may be mandatory. In other words, the device may not be able to connect to the communication network without being registered. In other embodiments, activation may be optional. As depicted at block 202, the method 200 may include entering a activation location. The activation location may include a website, the device itself prior to use as a communication tool, an activation kiosk at the location of purchase, or some other suitable location for providing activation/registration information. For example, the user may enter the website of the product manufacturer (e.g., the manufacture of the communication system device) via the World-Wide-Web. The primary user may be presented with a number of navigational options. For example, as depicted, the user may be provided the option of navigating to pages including a home page (block 204), a product catalog page (block 206), an activation page (block 208), a dealer locator page (block 210), a technical support page (block 212), or some other page (block 214) such as a frequently asked questions (FAQ) page. Selection of the activation page (block 208) may enable a user to navigate to a page to create a new user account (block 216) or login to view an existing account/information (block 218). Upon choosing create new user account (block 216), the user may be prompted or otherwise directed to a page to enter activation information (block 220). The activation page may prompt a user to enter/select a user-identification (user-ID) and/or a password. In one embodiment the system may prompt the user to reenter the user-ID and/or password to verify there are no typing errors. In one embodiment, a dialog box be displayed that informs the user that an account has been created. The user may then proceed to logout (block 222) or enter the account. Entering the account may enable the user to proceed directly to a welcome screen (block 224) or may require the user enter their user-ID and password before being directed to the welcome screen (block 224). The user may also access the welcome screen by navigating to the login screen (block 218) and entering the requested information.

The welcome screen (block 224) may provide the user with options and information relating to their account. For instance, once the primary user has entered their account, they may be provided an option to edit their account information (block 226), view current account information (block 228) or to logout (block 230). Other options may be available, such as terminating their account, and so forth. If the user chooses to navigate to the edit account information page (block 226), the user may be prompted to enter product identification information (block 232), such as a unit serial number and/or MAC address, along with vehicle user information (block 234), such as the primary user's name, state/country/province/etc. in which the vehicle is registered, make of vehicle, model of vehicle, year of vehicle, vehicle identification number, and/or license plate number, among other possible information. The user may then be given an option to submit the application (block 236) and the option to logout (block 238) or continue to validate information (block 240). The validation may request additional information of the user and/or may be an automated process that reviews or otherwise implements the provided information. For example, after the activation validation information method 200 may include verifying information provided by cross-checking to available databases of information and may include implementing a hash, checksum, checkdigits, or similar function to produces a product activation key from combined vehicle activation and device information. The hash function may be different for different classes or groups of serial numbers/MAC addresses to increase security, and the software can be updated as many times as desired with new hash functions in the event of the discovery of the hash function by hackers. The product activation key may then be made available to the user (block 242). For example, the product activation key may be displayed on a graphical display, e-mailed to a user account, printed, and/or downloaded to the communication device. In the event legal or vehicle information of the primary user/administrator is changed, the administrator/primary user may re-register and obtain a new product activation key.

The user may be redirected to view the current account information (block 228) and provided the options to logout (block 230), return to edit account information (block 226), return to other location on the site, or the like. It will be appreciated that the depicted embodiment is exemplary of an activation system and various configurations and techniques are contemplated. For example, the user may be provided an option to navigate to various portions of the site without having to navigate through various screens. For example, the user may be provide the option to logout at any time, or may be provided the option to view current account information directly from the initial set of options made available to them. Further, the user may be prompted for different forms of information than those listed herein. Moreover, as mentioned briefly above, in some embodiments, initialization, activation, and/or registration of the communication device may not be required or may be optional. For example, in certain embodiment, the device may produce an activation key from vehicle and/or personal information input by the user without an external activation utility. In one such embodiment, there may be no validation or authentication step, and the user may not be able to receive messages without inputting the proper identifier information (i.e. license plate number). Further, the device may not be of use to send unsolicited messages to receivers under a false identity because the receiver could detect that it was false by checking the location or proximity of the identifier of the sender. Activation thus may provide an additional level of security, but not necessary in all embodiments.

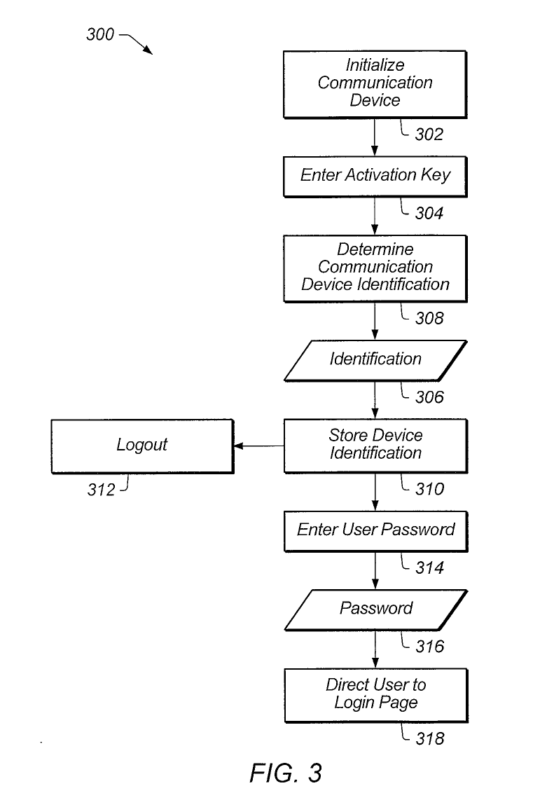

Turning now to FIG. 3, depicted is flowchart that illustrates a method 300 for operating/initializing a communication device in accordance with embodiments of the present technique. In certain embodiments it may be desirable for a user to perform some form of initialization or activation of each communication device that associates activation information (such as the user ID and/or vehicle identification) with the respective communication device such that it can be readily identified and verified on a network (e.g., the inter-vehicle communication network 100). For example, after completion of the activation process and receiving the product activation key (e.g., method 200), a user may take certain steps to enable the software of the inter-vehicle communication device. Such a process may help to ensure that each communication device is authentic, that users are who they claim to be, and otherwise provide an accountability that helps to ensure safe and secure use of each communication device. FIG. 3 is a flowchart that illustrates a method that can be implemented in software to initialize a communication device. The communication device may be initialized, as depicted at block 302. Initializing the device may include powering-on the device and/or answering various prompts or other navigational queues to enter an initialization function/operation of the communication device. The product activation key may be entered, as depicted at block 304. For example, a user may manually enter the activation key provided at block 242 of method 200. In some embodiments, the activation key may be e-mailed, wirelessly sent, or otherwise received at the communication device automatically. The method 300 may include determining an identification of the communication device, as depicted at block 306. In one embodiment, this may include extracting/parsing the activation key based on the same key used by activation software at block 240. One embodiment may include extracting/parsing an associated license plate number based on the product activation key. The identification 306 (e.g., the license plate number) may be produced and stored (block 310) by the device and along with a user-ID. In one embodiment, if the product key is invalid, the device is not activated. This may prevent the communication device from being associated with the improper license number and/or the improper vehicle. The hash function may be different for different classes or groups of serial numbers/MAC addresses to increase security. The software of the communication device may be updated as many times as desired with new hash functions in the event of the discovery of the hash function by unauthorized persons (e.g., hackers). A two-digit abbreviation for the state the vehicle is registered in can precede the license plate number in the device identification 310 to further decrease chance of duplicate license plate numbers across states. Once stored, the user may be provided the option to logout (block 312) or continue the to run the software. If the primary user chooses to logout, the program they may be directed out of the initialization functions to another screen. If the user opts to continue, the program may prompt the user to enter a password (block 314). The user may choose and verify a password 316. The password 316 may be stored in the communication device and used to verify the users identify each time the user logs into (e.g., begins use of) the communication device. With the account created based on the provided information, the user may be directed to the user accounts/login page for operating the communication device (block 318).

As discussed above, certain embodiments of a network, such inter-vehicle network 100, may be employed to exchange communications between two or more communication devices. The exchange of communication may include the transmission of data via the transmission of one or more communication signals between the two or more communication devices. The transmitted data may include a message packet, in one embodiment. A message packet may include a single piece of data (e.g., a bit), a single message consisting of multiple pieces of data, multiple messages, messages and associated transmission information (e.g., validation information), and the like. The data transmitted may be referred to herein as a “message packet” for simplicity, although it will be appreciated that “message packet” may be used to describe various combinations of data transmitted between communication devices. The transmission of message packets may enable a person using one communication device to transmit useful information to another communication device. The communication of information may be sent or received by a user of the communication devices, such as an operator of a vehicle in which the communication devices are located. As described with respect to FIGS. 1A and 1B the communication devices may be operated in short-range of long-range modes of operation to transmit message packets across various distances to recipients.

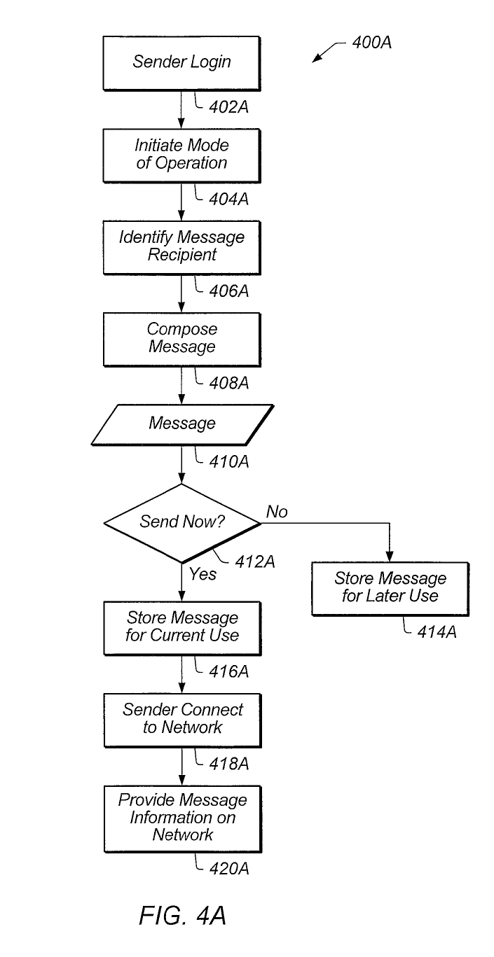

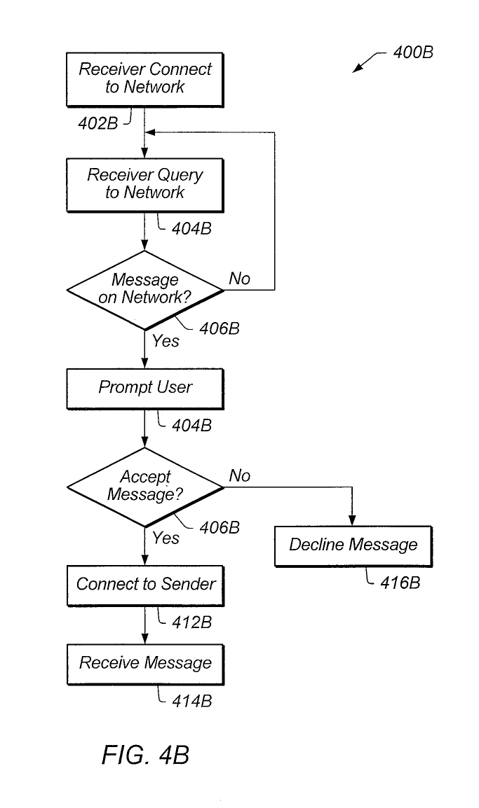

FIGS. 4A and 4B are flowcharts illustrating methods 400A and 400B of operating one or more communication devices in accordance with embodiments of the present technique. More specifically, method 400A is representative of a method of operating a source communication device that transmits a message packet via a communication signal. Method 400B is representative of a method operating a destination communication device that receives the message packet via the communication signal. Combined, FIGS. 4A and 4B illustrate one embodiment of cooperative operation of a source communication device and a destination communication device. In the illustrated embodiment, it is intended that the destination device is the intended recipient of the communication, although similar embodiments may be employed for intermediate devices participating in the transmission of the communication from the source device to the destination device via intermediate devices (e.g., in long-range mode).

FIG. 4A depicts a method of operation that includes generating, at one communication device on the network (e.g., an inter-vehicle network), a message for transmission via the a network and receiving the message at another communication device on the network. Method 400A generally includes initializing a sending device, composing a message packet (e.g., a message) at the sending device, storing the message, connecting to the network, and providing the message at a shared memory location on the network. Initializing the sending device may include logging-in to the communication device and initiating a mode of operation for the device. For example, method 400A includes a sender login as depicted at block 402A. In one embodiment, this may include a user powering on or otherwise accessing the communication device prior to sending a message. The login may include the user being prompted for and/or entering information such as the password (such as password 316 described with respect to FIG. 3). Further, the login may include a user verifying their license plate or other identification information. Based on the log-in information, the communication device may verify the user's identity. If the identify is validated, the communication device may continue to initiate a mode of operation, as depicted at block 404A. For example, a user may be prompted for or otherwise select between short-range and long-range modes of operation. Based on the selection, the communication device may perform intermittent device inquires and caching of network resource and location information. In one embodiment, this may include the communication device querying other communication devices within its transmission range and intermittently (or continuously) updating the location and resource information related to the communication devices within its transmission range. Where a GPS system is employed, information relating to communication devices inside and/or outside of the transmission range may also be assessed, determined and/or stored by the sending communication device. For example, the GPS coordinates of each of the communication devices outside of the transmission range may be provided to and/or stored by the communication device.

Method 400A may also include identifying a message recipient, as depicted at block 406A. Such an operation may be based on a request by the user to compose a message. For example, a user may navigate via an interface of the communication device to request to send a message to another communication device in the network. When prompted, the user may enter an identification of the communication device where the message is intended to be delivered to. For example, the user may enter a license plate of another vehicle. The license plate of the other vehicle may be associated with the intended recipient communication device in the vehicle. In another embodiment, the user may wish to send the communication to multiple recipients inside of or outside of the transmission range of the sending transmission device. In such an embodiment, the user may enter multiple license plate numbers, provide a request that the communication be sent to some or all of those within the transmission range, some or all of those outside of the transmission range, or to a particular group (e.g., all those communication devices registered to long-haul truck drivers). For example, the user may choose to send the communication to recipients within a certain distance or certain number of hops. In some embodiments, the identification of a communication device may not be the license plate number of the associated vehicle. For example, a vehicle may have a sticker in the widow that displays an identifier associated with the communication device in the vehicle. In such an embodiment, the user may enter the displayed identification number at step 406A.

Method 400A may include composing a message, as depicted at block 408A. For example, a user may compile a message 410A that includes the information they wish to communicate to an intended recipient. For example, the user may write a short textual message, the user may include files to be transferred, the user may select short pre-determined messages stored in memory and/or recall a message previously composed and stored in a memory of the communication device. Further, as depicted at block 412A, the user may be provided the option to send the message 410A now or to store the message for later use (e.g., such that the message can be retrieved and sent at a later time). If the user decides to store message 410A, the message may be stored in a memory of the communication device that can be accessed at a later time, as depicted at block 414A. For example, in one embodiment, message 412A may be stored in a non-shared folder (e.g., a folder that is not accessible by other communication devices on the network). Accordingly, message 412A may be retrieved, edited, sent and/or deleted at another time.

If the user decides at block 412A to send message 410A, the message may be stored for current use, as depicted at block 416A. In one embodiment, this may include storing the message in a shared folder (e.g., a message folder that is accessible/viewable by one or more other communication devices on the network). For example, in one embodiment, based on the identity of the message recipient provided at block 406A, the file may be stored in a location that is accessible and viewable by other communication devices on the network. For example, in one embodiment, the file name may be generated with an embedded identifier that is viewable and assessable by other communication devices to determine whether or not it is intended that message 410A be delivered to them. Similarly, an embodiment may include creating a folder where the message is stored that has a path embedded identifier that is viewable and assessable by other communication devices to determine whether or not message 410A is intended to be delivered to them. For example, in one embodiment, a folder specific to the recipient and/or message 410A may be created in a partitioned drive on the sending communication device. A label (e.g., a file path) associated with the file and/or folder may include, for instance, an identifier specific to the intended recipient(s). In one embodiment, the intended recipient's license plate number (or other identifier) may be included in the label (e.g., in the file name and/or file path). In one embodiment, a descriptor, such as a name, subject, or title associated with the message may be included in the file name and/or file path. In one embodiment, the identifier associated with the sending communication device (e.g., the license plate associated with the sending device) may be included in the label (e.g., the file name and/or file path). For example, in one embodiment, the file path may include the identifier associated with the sending communication device (e.g., server), the identifier associated with the intended recipient device (e.g., share), and the name of the file (e.g., file name). The resulting file path may be “\\server\share\filename” for example. In one embodiment, the folder may be created at the time the user request to send the message (e.g., at block 412A). In one embodiment, the folder may be created at the time the user composes the message or at some other time prior to providing message 410A on the network.

Method 400A may also include the sender connecting to the network, as depicted at block 418A. In one embodiment, connecting to the network may include the sending communication device connecting to the network with the vehicle license plate or other identifier as the device name. Connecting may include enabling other communication devices on the network to acknowledge the presence of the sending communication device, and/or to view shared folder or files stored on the sending communication device.

Method 400A may also include providing the message information of the network, as depicted at block 420A. In one embodiment, providing the message information may include placing the message in a location that is accessible by other communication devices on the network. For example, providing the message information may include placing the file and any associated information the shared folder accessible/viewable by other communication devices on the network.

FIG. 4B depicts a method of operation that includes receiving at one communication device on the network (e.g., inter-vehicle network 100) a message generated at another communication device on the network. Method 400A generally includes querying the network to determine if a message is intended for delivery to the communication device making the query, assessing whether a message is available that is intended to be delivered to the communication device, responding to the available message, and receiving or declining the available message. For example, method 400B includes a receiver device connecting to a network, as depicted at block 402B. In some embodiments, this may include a user of the receiver device (e.g., destination device) logging into the communication device in similar manner as to that described with regard to block 402A. The method 400B may also include querying the network, as depicted at block 404B. In one embodiment, querying the network may include scanning the shared memory locations of other communication devices to determine whether or not a message intended for delivery to the scanning communication device is present. For example, the communication device may scan the shared folder locations of other communication devices for a “shared” value in a file path (e.g., \\server\share\filename) that is associated with the communication device. For example, the scan may include parsing the label (e.g., file path and/or file name) for a value that is the same as or that is indicative of an identifier (e.g., a license plate number), a group name, or the like that is associated with the scanning communication device, and is indicative of the desire for the scanning communication device to receive the message. If it is determined that a message does not exist on the network that includes an identifier associated with the scanning communication device (block 406B), the communication device may continue to scan the network. For example, the communication device may scan the network at fixed intervals, radon intervals, or continuously. If it is determined that a message exists on the network (e.g., in a shared location of another communication device) that is intended for delivery to the communication device, the communication device may prompt the user and/or software in the communication device as to whether or not the message should be accepted for receipt, as depicted at blocks 408B and 408C. For example, if the communication device detects a folder path with the communication devices associated license plate number as the “share” in the file path, a message flag may prompt the user to determine whether or not they wish to connect to the “server” (e.g., the other communication device) to receive the message. In one embodiment, the communication device may access a portion of the message (e.g., a header or title) provided via the sending communication device (e.g., via the shared folder) and provide that additional information to the user to aid in the decision as to whether or not to receive the message. If the user decides to accept the message, the communication device may download the message. In one embodiment, the communication device may connect to the sender, as depicted at block 412B and receive the message, as depicted at block 414B. This may include mapping to the “network” drive of the sending communication device. The sending communication device may also verify the identification of the communication device before enabling the download of the message. For example, the sending communication device may verify the license plate number and/or the user password provided at login (e.g., at block 402B) before allowing the file to be copied/transferred from the shared memory of the sending communication device to a memory location of the communication device requesting receipt of the communication. If the user decides to not accept the message, the communication device may decline the message, as depicted at block 416B. Declining the message may include refraining from copying any portion of the message from the sending communication device and may include providing an appropriate response to the sending communication device, such as a message indicating that the user has declined to accept/receive the message. For example, in one embodiment, communication device may create a shared folder in a shared memory location that is accessible by the sending communication device. In such an embodiment, a message indicating that user does not intended to receive the communication may be placed in the shared folder with an identifier that indicates the message is intended to be delivered to the sending communication device. Similar the previously discussed technique, the sending device may also scan the network and identify the existence of the message marked for delivery to the sending communication device. Now operating in a manner consistent with a recipient communication device, the sending communication device can receive the message indicating the desire to reject the message. In some embodiment, the message may be predetermined message type such that the sending device automatically accepts the message without prompting the user of the sending device to accept or reject the message.

The techniques described with respect to FIGS. 4A and 4B may be used in both short-range and long-range modes. In short range mode, the communication, including the query of the network (block 402B) may include direct communication between the sending communication device and the receiving communication device. In long-range mode, the query may include relaying the inquiry from one communication device to another until the query reaches sending device. For example, the query may be broadcast from the receiving device to assess the presence of the message in a shared folder. In one embodiment, the sending communication device may broadcast an initial message to alert the intended recipient of the device as to the presence of the message. For example, in one embodiment, providing the message on the network (block 420A) may include broadcasting an initial flag message to the recipient communication device. In one embodiment, the flag message may include a predetermined message that indicates a message is available. The predetermined nature of the flag message may enable the receiving communication device to download the message without prompting the user of the receiving communication device for permission to continue. For example, the flag message may provoke the receiving communication device to direct a query to the sending communication device to assess the name and sender of the message, and the receiving device may receive this information and provide it to the user to decide whether or not to accept the message.

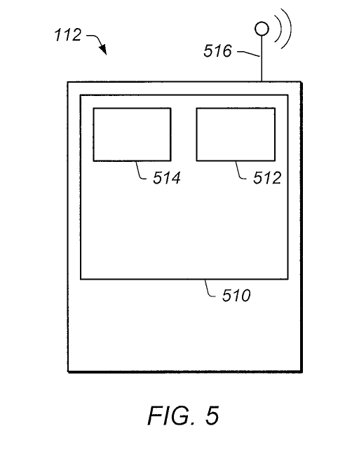

FIG. 5 is a block diagram that illustrates one embodiment of a communication device 112 in accordance with one or more embodiments of the present technique. In the illustrated embodiment, communication device 112 includes communication hardware and software 510, shared memory 512, non-shared memory 514, and transceiver 516. In some embodiments, the communication hardware and software 510 may include a central processing unit (CPU), power circuitry, display devices, input devices (e.g., a camera, a microphone, a keypad, or the like), bus controllers (e.g., universal serial bus (USB) controller), global positioning (GPS) module, and transceiver hardware, and/or additional memory (e.g., a hard-drive, random access memory (RAM), flash memory, or the like). Memory may be used to store application software, such as that implemented to operate various components of the communication device 112, firmware, device drivers, and the like. Memory may include a hard-disk drive, random access memory (RAM), a CD-ROM, flash memory, or the like capable of storing program instructions and files for use by communication device 112.

The shared memory 512 may include a memory location that is accessible by other communication devices on the network. For example, in one embodiment, other communication devices may be capable of mapping to the memory location to view and download information (e.g., files and messages) stored in the shared memory 512. In one embodiment, access to the shared memory location may be at least partially limited to external devices and/or users. For example, other communication device may be capable of viewing only certain information related to information stored in shared memory 512. In one embodiment, an external communication device may be capable of only viewing a file name or a portion of a file name associated with the stored information. For example, a communication device may only have access to view the “share\filename” portion of a file path including “\\server\share\filename.” Only after a response by the external communication device may additional information be made available. Such an embodiment may prevent unintended recipients from viewing information about what is stored on the communication device. For example, other communication devices may not be able to parse what two communication devices are exchanging information. In one embodiment, access to the shared memory location may not be limited. In such an embodiment, external devices may access and browse all or substantially all of the information stored in the shared memory location.

In one embodiment, the shared memory 512 may include a memory device and/or location completely separate from the communication hardware and software 510. For example, the memory location 512 may include a separate memory module reserved for shared information. In another embodiment, the memory location includes a partitioned memory location of a memory. For example, the shared memory location may include a portion of a system memory reserved for storing shared information. Other partitions of the memory may be used for storing application software, other non-shared memory locations. The partitions of the memory may be predetermined, or may be dynamically configured as messages are created and/or deleted.

The non-shared memory 514 may include a memory location that is substantially not accessible by other communication devices on the network. For example, in one embodiment, other communication devices may not be capable of mapping to the memory location to view and download information (e.g., files and messages) stored in the non-shared memory 514. IN one embodiment, access to the non-shared memory location may be limited to only certain communication devices on the network, but not all of them. In one embodiment, access to the non-shared memory location may be accessed by internal hardware and software of communication device 112. For example, the communication hardware and software 510 may be capable of writing and reading information to the non-shared memory 514, but other communication devices may not be capable of accessing or viewing information stored in non-shared memory 514. Non-shared memory may be employed to store information (e.g., files and messages) intended to be delivered at a later time. For example, non-shared memory 514 may be used to store drafts of messages, template messages, or the like that a user wishes to reserve for sending at a later time.

In one embodiment, the non-shared memory 514 may include a memory device and/or location completely separate from the communication hardware and software 510. For example, the memory location 514 may include a separate memory module reserved for non-shared information. In another embodiment, the non-shared memory 514 includes a partitioned memory location of a memory device used for storing multiple types of information. For example, the non-shared memory location may include a portion of a system memory reserved for storing only non-shared information. Other partitions of the system memory may be used for storing application software, other non-shared memory locations. The partitions of the memory may be predetermined, or may be dynamically configured as messages are created and/or deleted. In one embodiment, the non-shared memory may include portions of the system memory that are not partitioned and that are not shared.

Transceiver 516 includes, in one embodiment, a device configured to wirelessly transmit and/or receive communication signal between one or more communication devices. The devices may include other communication devices on the network, such as those associated with vehicles and/or non-vehicles. In one embodiment, the transceiver may include a Bluetooth radio. The Bluetooth radio may be employed to transmit signal in accordance with the Bluetooth communication protocol with other Bluetooth enabled devices, such as other communication devices having Bluetooth transceivers.

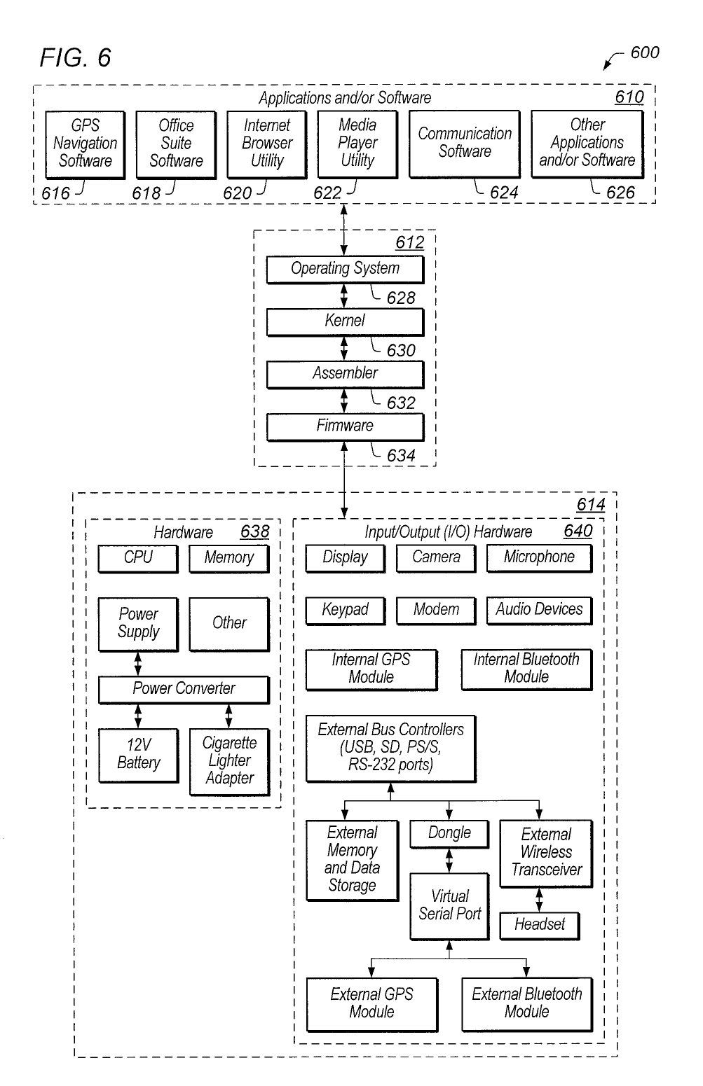

FIG. 6 depicts an embodiment of certain functional units 600 of the communication device 112 in accordance with embodiments of the present technique. The functional units may be contained at least partially in the communication hardware and software 510, discussed above with regard to FIG. 5. The functional units include applications and/or software 610, operational infrastructure 612, and hardware 614 for support of communication and other applications purposes. In one embodiment, applications and/or software 610 includes software for acquiring, formatting, and presenting data to and/or from a user of communication system 112. For example, application and/or software 610 may include GPS navigation software, 616, office suite software 618 (e.g., word-processing software), an Internet browser utility 620, a media player utility 622 (e.g., a music or movie player), communication software 624, and/or other applications and/or software 626. GPS navigation software may provide a standalone utility that the user may use for vehicle navigation, and may also provide positional information to the communication system for using in routing communication signals, for instance. Office suite software 618 may provide utilities, such as a word processor, spreadsheet, or similar program that can be used as a standalone application by a user, or may be employed for composing messages and files to be sent to other communication devices. Internet browser utility 620 may provide access to the Internet via the communication device 112. The media player utility 622 may enable a user to open and view media files (e.g., music or movies), such as those received from other users vehicles the communication device. Communication software 624 may provide applications for the creation, sending and receiving of messages via the communication device 112 and the network 100. Communication software 624 may be used in cooperation with other applications such as voice-to-text, text-to-voice, or similar programs to compose and review transmitted messages

Operational infrastructure 612 may support implementation of the applications and/or software with the hardware 614. Operational infrastructure may include an operating system 628, kernel 630, assembler 632, and firmware 634. Suitable operating systems may be dependent upon the infrastructure and language of the particular software used. In some embodiments, operating system 628 may include Windows, Macintosh, Linux, or the like.

Hardware 614 may include components that provide for storage of the associated software described above, general processing, user interface, and the transmission and receipt of messages in accordance with embodiments of the present techniques. Hardware may include may include operational hardware 638 and input/output hardware 640, as depicted. Operational hardware 638 may include a Central Processing Unit (CPU), memory, and a power supply, power converter, battery, cigarette lighter adapter, and the like. The memory may include shared memory 512 and non-shared memory 514, described above. The power supply may be independent or dependent on the vehicle power supply. For example, a power cord or power charger may be hard wired into an existing vehicle wiring system or be adapted to plug into a vehicle cigarette lighter. Input/output hardware 640 may include a display, keypad, camera, modem, microphone, audio devices, internal GPS module, internal Bluetooth module, external bus controllers, connection dongle, external wireless transceiver, headset, external GPS module, external Bluetooth module, external memory and data storage, or the like.

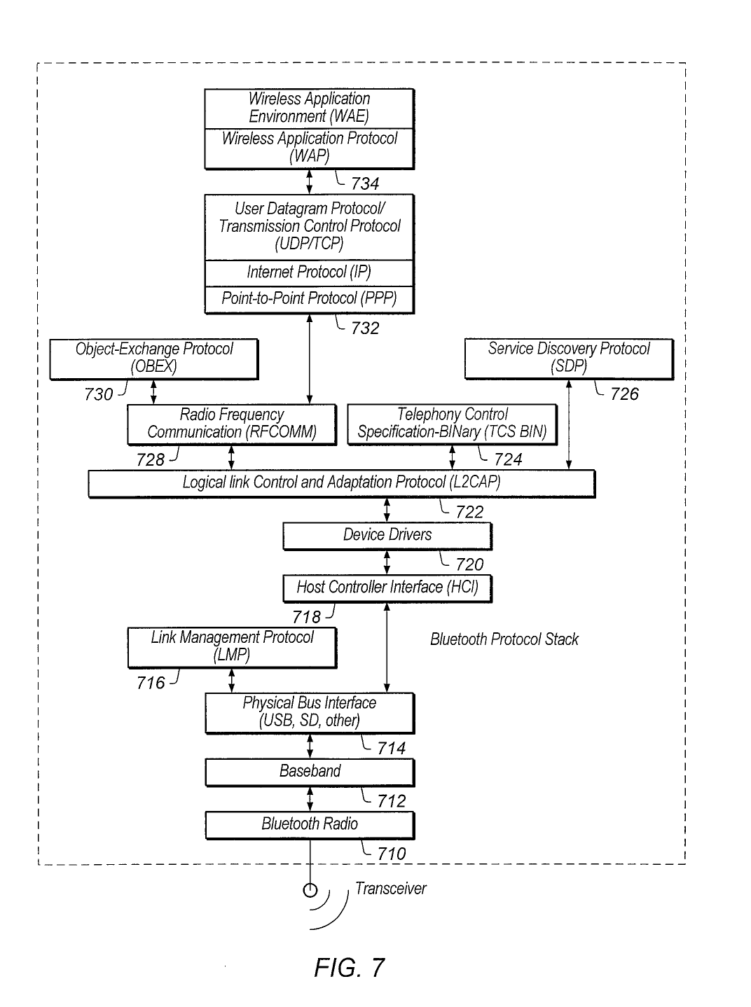

FIG. 7 is a block diagram that illustrates the integration of a Bluetooth transceiver with a user control interface and a physical bus interface in accordance with one embodiment of the present technique. In the illustrated embodiment, a Bluetooth radio/transceiver 710 may receive radio communication signals that are processed at baseband 712. Transceiver 710 connects to the physical electronic device via physical bus interface 714, which is managed by a link management protocol 716 and Host Controller Interface (HCI) 718. HCI 718 is further enabled by device drivers 720, which are further managed by the Bluetooth stack. The Bluetooth stack includes Logical Link Control and Adaptation Protocol (L2CAP) 722; Telephony Control Specification-BINary (TCS BIN) 724; Service Discovery Protocol (SDP) 726; Radio Frequency COMMunication (RFCOMM) 728; OBject-EXchange Protocol (OBEX) 730; Point-to-Point Protocol (PPP), Internet Protocol (IP), and User Datagram Protocol/Transmission Control Protocol (UDP/TCP) collectively labeled as 732; and Wireless Application Environment (WAE) and Wireless Application Protocol (WAP) collectively labeled as 734. In some embodiments, other protocols, such as a SWAP protocol, or a similar protocol, may also be used instead of a Bluetooth protocol.

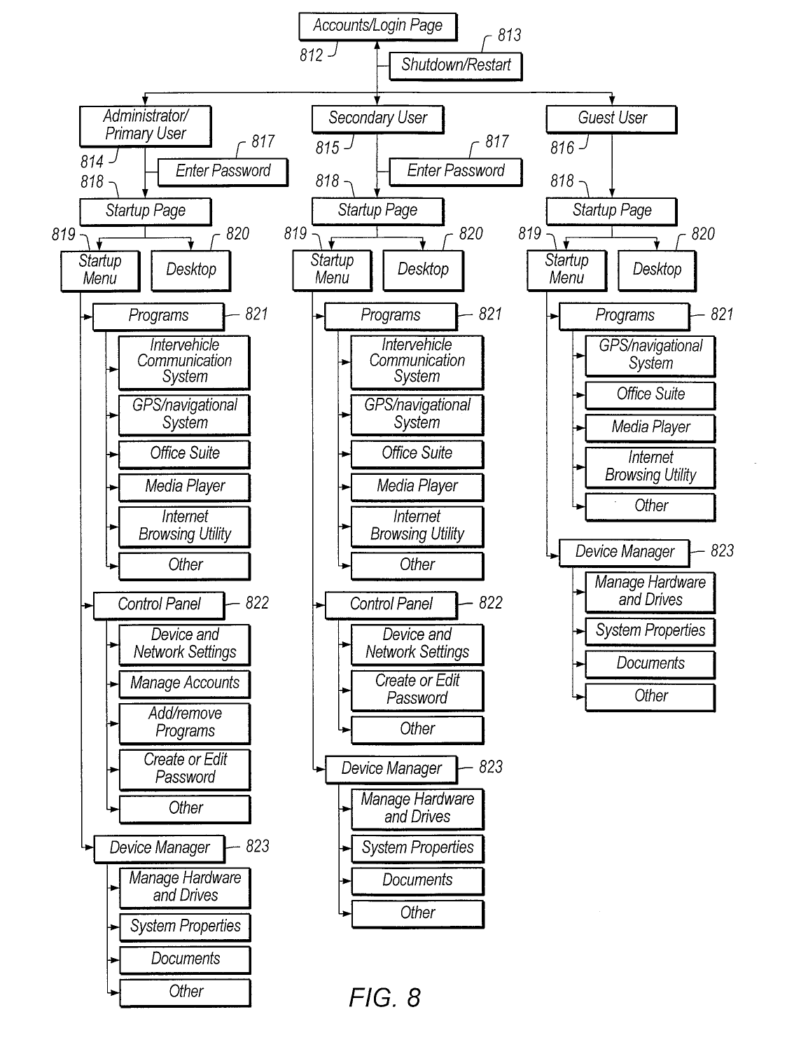

FIG. 8 is a block diagram that illustrates integration of an inter-vehicle communication program with an operating system and complimentary programs and utilities in accordance with one or more embodiments of the present technique. A user may navigate through the displayed arrangement of functions to send/receive a message from other communication devices via the network or to make use of other functions provided by the communication device. For instance, an accounts/login page 812 may contain a shutdown/restart option 813, an administrator/primary user account 814, a number of secondary user accounts 815, and a guest user account 816. The administrator/primary user account 814 and secondary user accounts may be protected by a password function 817. Each account may open to a startup page 818, where the user may navigate to a startup menu 819 and other options contained on a desktop screen 820 according to the respective operating system. A number of programs 821, a control panel 822, and a device manager 823, among others, may be accessible to the user through startup menu 819 and/or desktop screen 820. Administrator/primary user 814 and secondary user 815 account programs may contain inter-vehicle communication system software, along with GPS/navigational system, office suite, media player, an interne browsing utility, and other programs, such as those described with respect to application software 610 of FIG. 6. Guest users 816 may not have access to the inter-vehicle communication system program. This may prevent unauthorized use of the communication device to send/receive message to/from other communication devices on the network. The administrator/primary user account 814 may add or remove programs, change their account password, access and edit device and network settings, manage accounts, among others, from control panel 822. Device settings may include display settings, date and time, touch screen sensitivity, and other similar settings. Secondary users may have similar control panel options, but only the administrator or primary user may manage accounts and programs, in some embodiments. Such restrictions may help to secure the network by ensuring only certain persons can expand or restrict access to send/receive messages to/from other communication devices on the network. Secondary users may edit device or network settings and the secondary user account password, among others. Guest users may not have access to the control panel. The device management utility 823 may be the same for all accounts, and include hardware and drive management utilities, system properties viewer, and a document access utility, among others. The inter-vehicle communication device may require an inter-vehicle communication program open to send and receive messages.

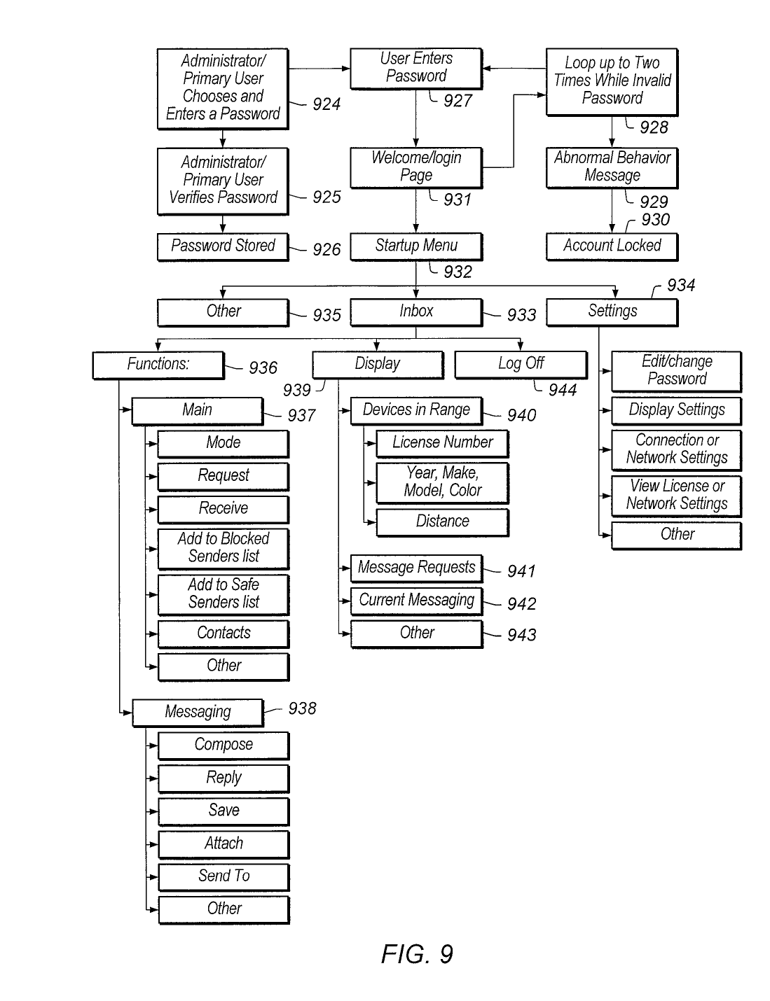

FIG. 9 is a block diagram that illustrates organization of a number of possible functional units included in an inter-vehicle communication program and associated graphical user interface in accordance with one or more embodiments of the present technique. The administrator/primary or secondary user may first choose and enter a password upon initialization of the inter-vehicle communication system program, as depicted at block 924, and verify the password by typing it once again, as depicted at block 925. The password may be stored in a partitioned area of the program, as depicted at block 926, and the administrator/primary or secondary user may input the password, as depicted at block 927, to enter the program. A loop mechanism 928 may inform the user that the password is incorrect and ask the administrator/primary user to reenter the correct password while the password is incorrect. If the administrator/primary or secondary user has forgotten their password, they may be prompted to enter personal or vehicle information of the administrator/primary user for verification, after which an email may be sent to the administrator/primary user containing instructions on how to reset the password. If an incorrect password is entered a predetermined number of times (e.g., three times), an abnormal behavior message, as depicted at block 929, may be sent to the administrator/primary user via an email address entered during the online activation process, informing the administrator/primary user that all device accounts have been locked, as depicted at block 930, by a function and that the device may be reactivated by reregistering online.

Once the administrator/primary or secondary user has entered the welcome/login page (block 931) and entered the appropriate password, a startup menu may appear which contains options such as enter inbox (block 933), settings (block 934), or other similar options (block 935). Inbox (block 933) may include a functions menu, as depicted at block 936, including main functions (block 937) such as “mode,” “request,” “receive,” “add to blocked senders list,” “add to safe senders list,” and “contacts,” among others. The function “mode” may enable a user to choose a short-range or long-range mode of communication according to one embodiment. The function “request” may open a messaging window allowing the user to send a message request to a similar inter-vehicle communication apparatus. The function “receive” may open a messaging window allowing the user to receive an incoming message from a similar inter-vehicle communication apparatus. The function “add to blocked senders list” may enable a user to add a similar inter-vehicle communication device to a registry which includes devices in which the user does not wish to receive messages from. The function “add to safe senders list” may enable the user to add a similar inter-vehicle communication device to a registry including trusted devices, and enable the user to receive messages automatically from the particular device without having to first choose the “receive” function. The function “contacts” may enable a user to access, edit, and select from a registry of often used or favorite similar inter-vehicle communication devices chosen and added by the user for faster messaging. Additional functions may allow a user to send a message to all similar inter-vehicle communication devices in a certain radius or number of hops of the device.

Function menu (block 936) may also include messaging functions (block 938) such as “compose,” “reply,” “save,” “attach,” and “send to,” among others. The function “compose” may enable a user to initiate a message composition to send to a similar inter-vehicle communication device. The function “reply” may enable a user to respond to a message received from a similar inter-vehicle communication device. The function “save” may enable the user to copy and save a message or entire series of messages (i.e. conversation) from and between a similar inter-vehicle communication device to a memory for later referral. The function “attach” may enable a user to send a file from memory along with a message to a similar inter-vehicle apparatus. The function “send to” may allow a user to send a file received from a similar inter-vehicle communication device to a destination in the device's memory or open the file in a specific program.

Main display window (block 939) may also be accessed through inbox (block 933), and may present to the user information for all similar inter-vehicle communication devices in range (block 940), as well as all current message requests (block 941) and active message windows (block 942), among others (block 943). Information displayed pertaining to all similar devices in range may include: license number of vehicle in which the device is located and registered; year, make, model, and color of vehicle in which the device is located and registered; and/or distance from user device.

In certain embodiments, users may choose to log out by function (block 944) from inbox (block 933). Users may also access a settings window (block 934) from inbox (block 933) that may enable the user to edit a program password, edit display settings, edit connection or network settings, or view license and registration information, among others. In one embodiment, license and registration information may only be edited via the online activation system.

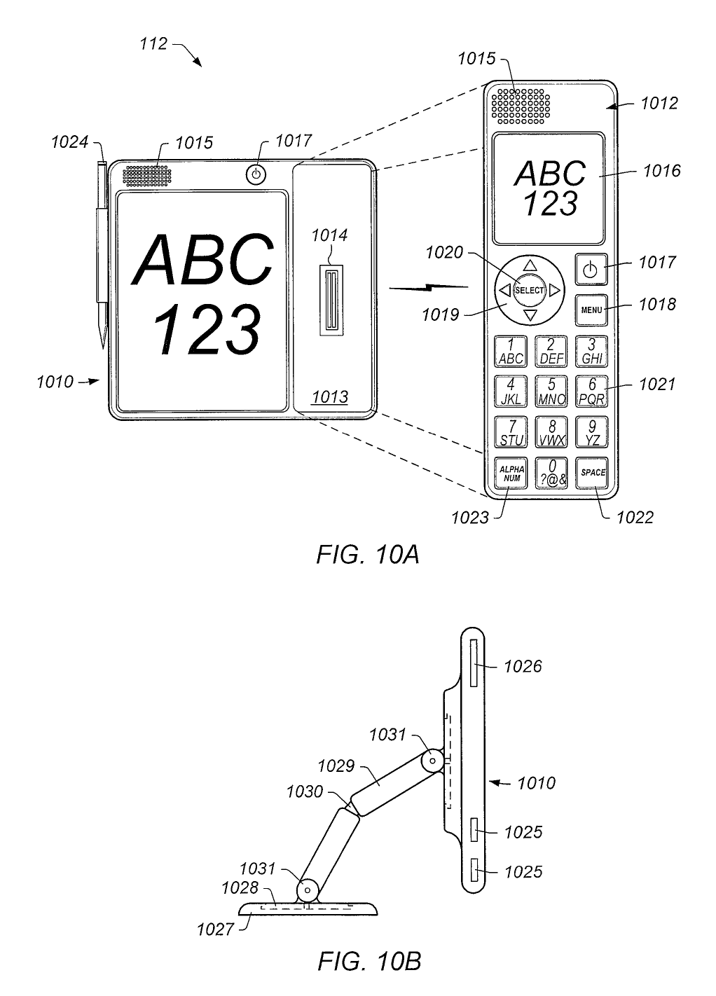

Embodiments of communication device 112 may be adapted for use in various locations. For example, where the communication device is to be used as an inter-vehicle communication device, it may be mounted somewhere within a vehicle that is conducive to use by the vehicle occupants. For example, in one embodiment, communication device 112 may be fixedly or removable attached to a forward portion of a vehicle's interior such that it can be accessed and operated by a vehicle operator or passenger. FIGS. 10A-13C illustrate various embodiment of communication device 112. FIGS. 10A and 10B illustrates communication device 112 mounted on an interior surface of a vehicle, such as a dashboard or windshield, in accordance with one embodiment of the present technique. A portable electronic device 1010 serves as a base station for a remote 1012. Remote 1012 attaches to base station 1010 via a docking platform 1013. In the illustrated embodiment, remote 1012 includes a rechargeable battery pack that couples to a power adapter 1014 provided on or near docking platform 1010. In one embodiment, base station 1010 may establish a wireless connection with remote 1012, via a Bluetooth or SWAP protocol for example. In one embodiment, base station 1010 may include an independent power supply that can be coupled to a vehicle power supply via a cigarette lighter adapter within the vehicle, or directly wired to a vehicle power supply. Either or both of base station 1010 and remote 1012 may include a combination speaker/microphone 1015, a touch display screen 1016, and a standby switch 1017. Standby switch 1017 may also serve as a power on/off switch in on embodiment. Remote 1012 is further comprised of a user interface which may includes a menu option 1018, omni-directional pointing and navigational utility 1019, selection tool 1020, alphanumeric keypad array 1021, and other word processing functions to facilitate the construction of textual messages, such as a space bar 1022 and an option input 1023 that enables the user to switch from alphabetic to numeric entry, and vice-versa. The base station 1010 may also include an additional stylus 1024 that can be used in conjunction with the touch-screen display 1016 of base station 1010 and remote 1012, along with a number of Universal Serial Bus (USB) ports 1025 and Secure Digital (SD) memory card ports 1026. Dedicated mounting hardware may be integrated into the base station 1010 for mounting base station 1010 to a forward interior surface of a motor vehicle. In the illustrated embodiment, included is a disk 1027 coupleable to an interior vehicle surface (e.g., via suction or an adhesive coating), swivels 1028 (e.g., rotatable in three-hundred-sixty degrees), and arms 1029 connected via swivel 1030 (e.g., rotatable in three-hundred-sixty degrees). In the illustrated embodiment, base station 1010 and disk 1027 are each coupled to a swivel 1028, and to the arms 1029 via swivels 1031 (e.g., rotatable in three-hundred-sixty degrees). In one embodiment, a product logo may be displayed on one or both of the base station 1010 and remote 1012.

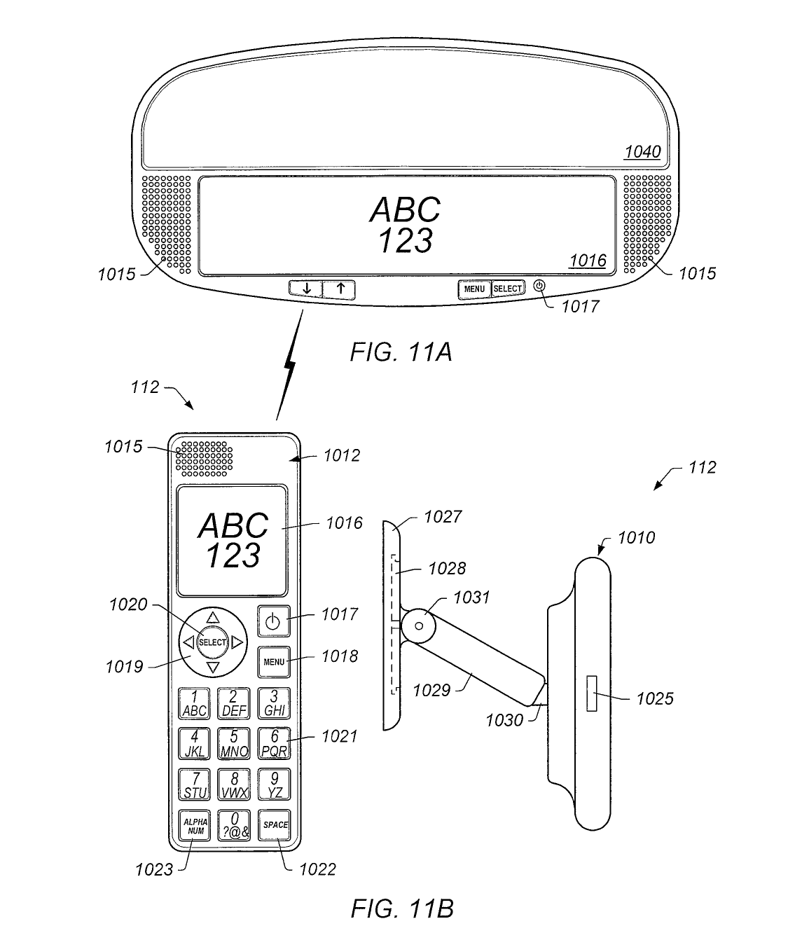

FIGS. 11A-11B illustrate communication device 112 for mounting as or integrated with a rearview mirror of a vehicle in accordance with one embodiment of the present technique. Portable electronic device 1010 serves as a base station for a remote 1212 as discussed with regard to FIG. 10. In the illustrated embodiment, base station 1010 includes a rearview mirror 1040 in addition to features described above with regard to FIG. 10. Accordingly, in one embodiment, communication device 112 can be mounted to the interior of a car windshield or other location traditionally reserved for a rear-view mirror.

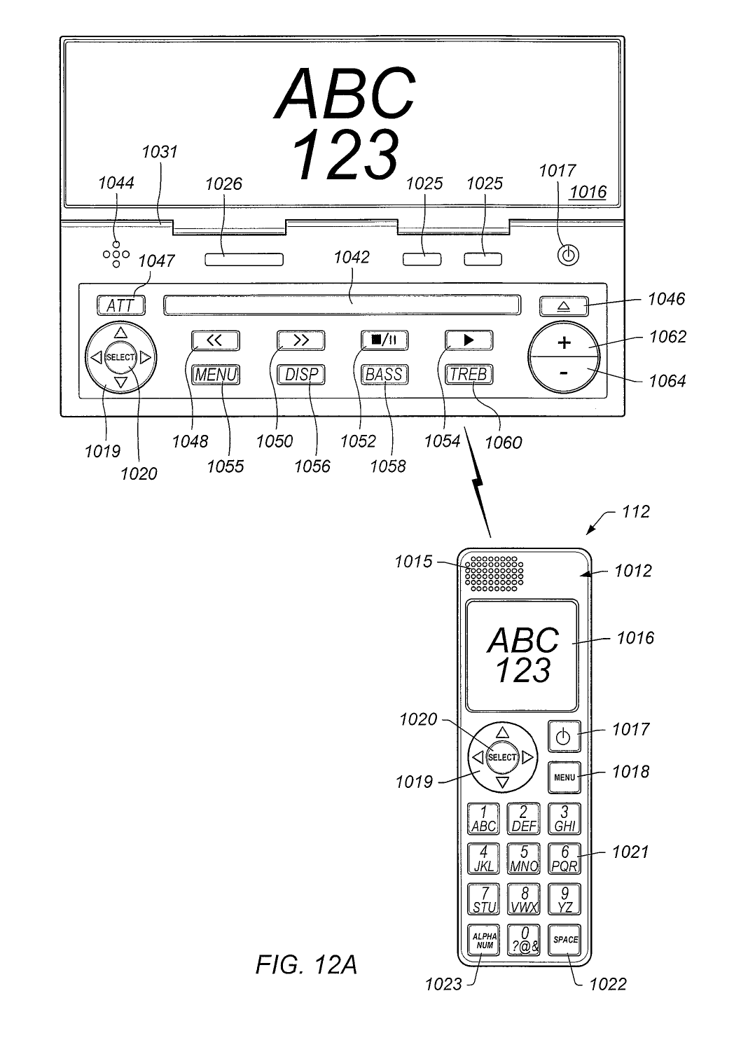

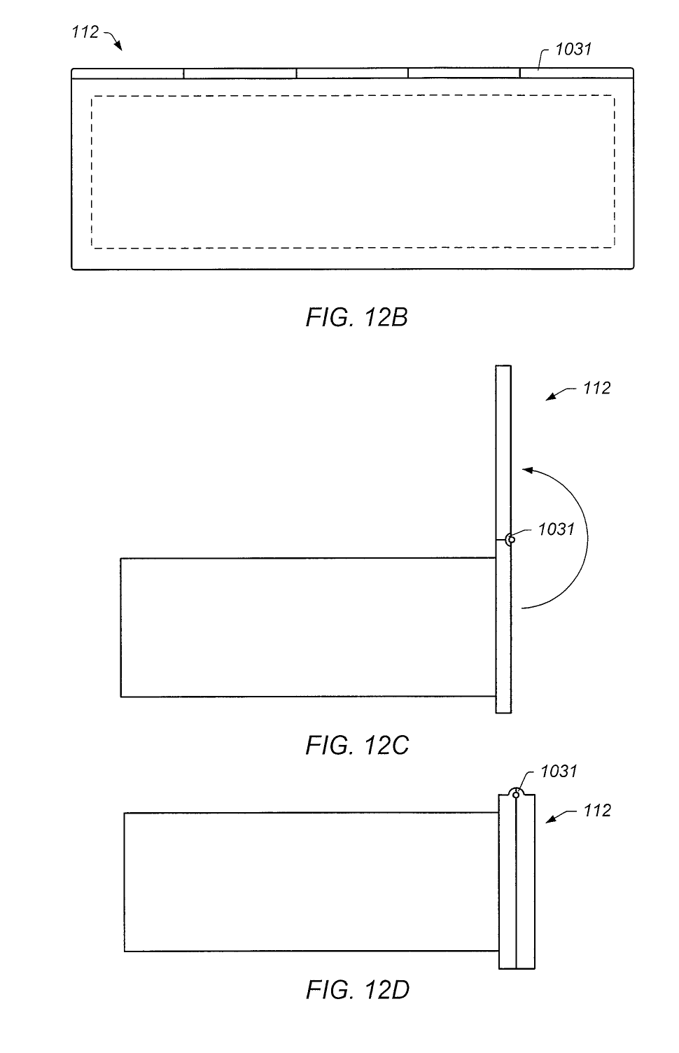

FIGS. 12A-12D illustrate communication device 112 for mounting in conjunction and/or integral with an in-dash radio or audio system of a vehicle in accordance with one embodiment of the present technique. Portable electronic device 1010 serves as a base station for a remote 1212 as discussed with regard to FIG. 10. In the illustrated embodiment, base station 1010 includes a CD-ROM drive 1042, microphone 1044, open/close (i.e., eject) CD ROM utility 1046, and an “Attention” button 1047 which allows the user to quickly place audio systems on standby (e.g., at drive-through windows, busy intersections, a case in which a passenger of the vehicle receives a cellular telephone call, et cetera). Also included in base station 1010 is a combination seek broadcast station/skip audio track controls 1048 (back) and 1050 (forward), a stop/pause utility 1052, play utility 1054, menu utility 1055, change display settings utility 1056, bass control 1058, treble control 1060, volume up 1062 and volume down 1064. Base station 1010 may also include a hinge mechanism 1031 that enables the display to be folded between opened and closed positions. For example, hinge mechanism 1031 may enable the display 1016 to be folded down and over the controls, as depicted in FIG. 12B. FIG. 12C illustrates communication device 112 in an open position in which the display screen is up in the open position. FIG. 12D illustrates communication device 112 in a closed position in which the display screen is folded down to cover substantially all of the lower portion of the face of the unit exposed to the user. As illustrated, in the closed position, the unit may provide a visually appealing module that can easily be integrated into existing vehicle entertainment systems. For example, the illustrated unit may be suitable for use in a single-DIN console opening of a vehicle dash. Other embodiments may have a size suitable for use in a double-DIN console opening of a vehicle dash. In one embodiment including a communication device 112 suitable for use in double DIN console opening, a fold down screen may not be employed. In one embodiment, substantially all of the face of the unit may include a display and/or touch screen.

In some embodiments, the display system may be of the cathode ray tube (CRT) type, Liquid Crystal Display (LCD) type, or the like. The inter-vehicle communication device may also be integrated with the vehicle's audio system and/or include dedicated speaker devices. An antenna appropriately attached to an exterior of the inter-vehicle communication device, or the motor vehicle it is located within, may be used to increase transmission range. Transmission range may also be extended by amplifying the power input to the transceiver of communication device 112. A wireless headset/microphone combination may be used for hands-free operation of the device.

Communication network 110, in one embodiment, includes two or more communication devices 112. For example, as discussed with respect to FIGS. 1A-4B, two communication devices may communicate wirelessly with one another. Each of the communication devices may include similar configurations, such that they process information and transmit information in a similar manner to one another. For example, each communication device may include a configuration similar to that described with regard to FIG. 5, and use their respective shared memory 512 to store and transmit information to one another.

As discussed briefly above, wireless communication may be provided via any suitable communication protocol. For example, the communication devices may exchange data in accordance with Bluetooth, Shared Wireless Access Protocol (SWAP), and/or Shared Wireless Access Protocol-Cordless Access (SWAP-CA). In some embodiment, suitable transceivers can be formed from relatively inexpensive complementary metal-oxide-semiconductor (CMOS) integrated chips that may connect to a device through a Universal Serial Bus (USB) interface, for example.

The SWAP and SWAP-CA specifications may provide a conduit for secure, no-cost communication between previously “known” devices that can provide specific information about each device a posteriori (e.g., based on previous experience or knowledge of the device). In certain embodiments, SWAP may be used to communicate with a device that has provided a pass-key or other identifier that verifies the identity of the device. In certain embodiments, SWAP operates in the 2.4 GHz band, utilizes a frequency hopping scheme at 50 hops per second, and is capable of transferring data at a rate of one to two megabits per second (Mbps). In some embodiments, SWAP can support up to six near-line quality voice connections and uses 100 milliwatts (mW) to transmit power and may include a 40-bit encryption algorithm for security, and enable extended battery life.

Bluetooth is designed to negotiate communication between known devices at short distances. Bluetooth may be operated on the Industrial, Scientific and Medical (ISM) radio bandwidth at 2.4-2.4835 GHz and may enable low-power, short-range communication or transfer of information between devices over a secure, globally-licensed radio frequency. The basic components of a Bluetooth system may include a Radio-Frequency (RF) transceiver, baseband, and protocol stack. Such a system has been described above with respect to at least FIG. 7. A Bluetooth adapter may enable multiple devices to communicate with a single device simultaneously within a radius from one to 100 meters, depending upon the power class of the device(s). A “master” device can connect with up to seven other active devices called “slaves” to form a “piconet,” and bring up to 255 inactive devices into active status. If one device acts as a master in one piconet and a slave in another, multiple piconets can be connected to form a “scatternet.” A transmission range of approximately ten meters may be achieved with 0 dBm (1 mW), and 100 meters with 20 dBm. The addition of an external power amplifier may extend the transmission range of a communication device. Minimum and maximum power output identified may include s −70 and 20 dBm, respectively, as defined by the Bluetooth standards.

Generally for one Bluetooth-enabled device to currently establish a connection with another, the user of one device may perform an inquiry to search for devices within range, and select the address of the device it wishes to establish a connection with. A user can replace the address with a username, and the username will appear instead of the address. For a remote device to use the services of another device, the two enabled devices may be “paired.” Pairing is established by authenticating the identity of the devices with a “passkey,” which can be learned and input by both user(s). After two devices are paired, future authentication may be performed automatically for connection between those two devices. In other words, in the event the user of a particular Bluetooth-enabled device, denoted as User1, wishes to contact or exchange information with the user of another Bluetooth-enabled device, denoted as User2, the passkey of User1's device may need to be predetermined by User2. Additionally, two pieces of information may need to be predetermined by User1: the address or username of the device they wish to contact and the passkey of the device they are attempting to contact.

Alternatively, unsolicited messages of limited length can be sent via “bluejacking” to Bluetooth-enabled devices within range using OBject-EXchange (OBEX) protocol, and may include the message in the name field. However, without the input of User1's passkey by User2, typically no further communication can occur unless all security measures of both devices are disabled, making the devices extremely vulnerable to hackers.

Bluetooth may be used to connect wirelessly to known devices such as a personal computer, headset, home phone, or other similar components at no cost. In certain embodiments, Bluetooth range my be extended via wireless ad hoc communication standards, such as “hopping” described above with respect to FIG. 1B. Transmission range can be extended by hundreds of feet to even a few miles or more by increasing the power output of the device and concentrating the radio signal, further increases to relatively longer ranges may be difficult. Alternatively, a user may access Mobile Ad-hoc NETworks (MANETs) or Wireless Ad-hoc NETworks (WANETs) for long-range communication. MANETS include Vehicular Ad-hoc NETworks (VANETs) and Intelligent Vehicle Ad hoc NETworks (InVANETs), which are further adapted for use in wireless inter-vehicle communication.

MANETs generally provide for wireless communication between arbitrarily organized mobile electronic devices called nodes. Nodes may route packets of information to a number of other nodes, which forward the packets to other nodes, and so on until a target node or terminal condition is reached, allowing a node to contact a number of other nodes outside of its transmission range. MANETs have an unfixed infrastructure characterized by highly variable and unpredictable energy availability, bandwidth availability, resource availability, and resource locations. Due to such a nature, nodes do not have a priori knowledge of network topology or surrounding nodes, and as a result may discover them dynamically. Resource discovery architectures may be categorized as either “location-aware” data and position query mechanisms, meaning node location information is available, or “location-free” data-only query mechanisms, meaning node location information is not available. The method in which a node updates or queries a number of node positions in order to send information may be further classified as either proactive (table-driven) or reactive (on-demand). The following is a non-exhaustive subset of resource discovery schemes that may be employed in certain embodiments include Flooding-based techniques, On-demand routing techniques, Quorum-based techniques, and/or Hybrid (loose hierarchical) techniques. In reactive, location-free flooding approaches, a message may be forwarded with every message and discovery request until all nodes in a network have received it. Each node may have a loop prevention algorithm that prevents the message from being forwarded more than once. Simple flooding may result in unnecessary or redundant transmissions. A number of variations to flooding techniques may also be employed in certain embodiments. For example, scoped flooding, or Expanding-Ring Search (ERS). ERS includes a limit on the distance or number of times (number of “hops”) a message is forwarded. If a resource is not found, the hop limit (TTL) is increased by an increment and flooding is repeated until the resource is found. One example of a location-aware flooding technique is Reduced Broadcasting (RB) techniques, which further reduce transmission redundancies common to flooding by including heuristics to analyze node density. Certain embodiments may include probabilistic forwarding, count of message receptions, node location, and/or node distance. Examples of flooding techniques include Simple Location Service (SLS) and DREAM Location Service (DLS).

In certain embodiments, On-Demand Routing (ODR) employs a caching algorithm to form and store “routes” from a source to a target node for use on-demand. Nodes may maintain a table of neighboring node identifiers, locations, and route information to assist in message forwarding which may be updated proactively or reactively. If a cache is not found locally, a source may query its neighbors for a cache or flood the network. Proactive protocols may continually update tabulated route information at set time intervals when the device is turned on, while reactive protocols may only update route information upon initiation of a message request. Proactive protocols may offer reduced time for a source node to locate a target node, while reactive protocols may offer the improved use of available bandwidth and energy. Examples of on-demand routing techniques include Dynamic Source Routing (DSR), GRID, Location Aided Routing (LAR), Ad-hoc On-Demand distance Vector routing (AODV), and Reactive Location Service (RLS).

In certain embodiments, a quorum-based technique may be employed in which every node in a network may not store all location information for all other neighboring nodes. Instead, a network of nodes may implicitly (hashing functions) or explicitly (geographically) agree upon a number of dominant nodes to act as location servers. The location servers may store each node's identifier and location information within a designated region. Regions may be the result of a geographic area being divided into columns and rows, a cluster of dominant nodes, or similar. Location queries are routed to and looked up at the location servers, which may also be referred to as “rendezvous points.” Location servers may be hierarchical or symmetric (“flat”) in their roles, and may be chosen based on dynamically formed clusters of nodes, landmarks, or a given region. Location servers form what may be referred to as a “dominating set,” or “backbone,” through which messages are sent. Although in quorum-based techniques the node chosen to be a server may be overloaded, and failure of a location server can significantly affect a network's ability to function, quorum-based techniques provide for a scalable architecture. Examples of quorum-based methods include GRID Location Service (GLS), Octopus, GeoQuorums, Rendezvous Regions (RR), Geography-based Content Location Protocol (GCLP), Geographic Hash Table (GHT), Multi-Zone Routing (MZR), Locality aware Locating Service (LLS), Terminodes, SLALoM, Distributed Location Management (DLM), and Geographical Region Summary Service (GRSS).

In some embodiments a hybrid routing technique may be employed in which a node establishes and maintains a zone independently that consists of neighboring nodes within a number of hops, and forms a loose hierarchy. In the event the node wishes to contact a number of other nodes, a proactive mechanism may be used intra-zone, while a reactive mechanism may be used inter-zone. Border-casting is one inter-zone routing technique, and may include flooding between a zone's peripheral nodes with a loop prevention mechanism to prevent or reduce redundant querying. In certain embodiment of border-casting, a querier sends a message request to its border nodes, and the border nodes send it to their border nodes, and so on. Such resending of a message request may be referred to as multicasting. Another embodiment of an inter-zone routing technique may avoids border-casting and may be based on contact-nodes elected out of the zone which are queried on-demand. In such an embodiment, contacts are selected and maintained via single-shot or multiple expanding trials to reduce zone-overlap, increase coverage, and reduce energy used. Contact-based schemes may help to conserve bandwidth and energy. Examples of hybrid routing techniques may include the Zone Routing Protocol (ZRP), Contact-based Architecture for Resource Discovery (CARD), Mobility-Assisted Resolution of Queries (MARQ), and Transactions Routing for Ad-hoc NetworkS with eFficient EneRgy (TRANSFER).

In certain embodiments of inter-vehicle communication described herein, quorum-based routing methods may provide scalability suitable for larger networks. In particular, such methods may be efficient in combination with geographical routing aids to provide reductions in overhead, enhanced route discovery, and reduction in number of queries. Methods that meet this criteria may include Location Aided Routing (LAR), location-based multicast algorithms (Geocasting, GeoTORA), location-based unicast algorithms such as Distance Routing Effect Algorithm for Mobility (DREAM), Greedy Perimeter Stateless Routing (GPSR), a scalable location service for geographic ad hoc routing (aka GRID/GLS), and Rendezvous Regions (RR).

In certain embodiments, GLS utilizes a geographic forwarding technique similar to Finn's Cartesian Routing (FCR). Each device, or node, in a network may be equipped with a Global Positioning System (GPS) unit and may determine its latitudinal and longitudinal position. Each node may proactively sends packets of information (aka “HELLO” packets) to its neighbors, which include an announcement of its presence, geographic position, unique random identifier (can be license plate number in the case of the present invention), a timestamp, velocity, etc. The header of a packet destined for a particular node may contain at least the source node's unique identifier and geographic position. Each node can then maintains a member table containing current neighbor's identifiers and geographic positions for use on-demand. Upon sending a message to a number of target nodes, a source node may consult its member table and sends the message to a neighbor closest to the target node(s), which itself may forward the message to its closest neighbor to the target(s), and so on. Such an algorithm may cease when the target node(s) is reached. If there exists a dead end in the geographic forwarding, or if no location caches can be found, scoped flooding may be used in one embodiment.

In certain embodiments, RR may incorporate use of rendezvous regions instead of rendezvous points, where each region is a geographical subset of the network topology. Elected nodes inside each region may be responsible for maintaining a set of keys that contain service and data information. Such keys can be mapped to a specific region using a hash-table scheme similar to GHT. Service or data providers periodically update their information in the corresponding regions for retrieval upon request by service or data seekers. RR has an advantage over point-based methods in that it is more tolerant to node failure and mobility.

Trajectory-based forwarding (TBF) may be used in another embodiment. Generally, it does not necessitate the use of detailed location information for the target node. Further, it may work well in dense networks where a predefined trajectory can be embedded in the information packet to be sent to the target node. Intermediate nodes may forward the packet of information to other nodes that lie closest to the path of the trajectory. A trajectory may not include specific nodes along the path, and so is unaffected by holes or changes in network topology.

As mentioned previously, various embodiments of the above-described techniques may be used in conjunction with the techniques described above to provide secure wireless communication and/or file transfer at any range between devices (e.g., communication devices) previously unknown to each other based on information provided solely a priori.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to.

What is claimed is:

1. A method of wireless inter-vehicle communication, comprising:
storing a message packet in a shared memory location of a first communication device, wherein the shared memory location is wirelessly accessible by one or more other communication devices;
assessing, at a second communication device, whether or not the message packet stored in the shared memory location of the first communication device is intended to be received at the second communication device;
assessing, at the second communication device, whether or not to accept the message packet from the shared memory location of the first communication device; and
if it is determined that the message packet should be accepted from the shared memory location of the first communication device, receiving at least a portion of the message packet at the second communication device.

2. The method of claim 1, comprising providing a rejection message to the first communication device if it is determined that the message packet should not be accepted from the shared memory location of the first communication device.

3. The method of claim 1, wherein assessing whether or not to accept the message packet from the shared memory location of the first communication device comprises the second communication device prompting a user as to whether or not to accept the message packet from the first communication device.

4. The method of claim 3, wherein prompting the user as to whether or not to accept the message packet from the first communication device, comprises providing at least an identification associated with the first communication device.

5. The method of claim 1, wherein storing the message packet in a shared memory location of a first communication device comprises storing the message packet with a file path that is configured to enable identification of the first communication device and the second communication device.

6. The method of claim 1, wherein storing the message packet in a shared memory location of a first communication device comprises storing the message packet with a file path that includes an identifier associated with the first communication device, an identifier associated with the second communication device and a descriptor of the message packet.

7. The method of claim 1, wherein the shared memory location is wirelessly accessible by one or more second communication devices via at least one of Bluetooth, Shared Wireless Access Protocol (SWAP), and Shared Wireless Access Protocol-Cordless Access (SWAP-CA).

8. The method of claim 1, wherein the shared memory location is wirelessly accessible by one or more second communication devices via direct communication between the first communication device and the second communication device in a short-range mode.

9. The method of claim 1, wherein the shared memory location is wirelessly accessible by one or more second communication devices via indirect communication between the first communication device and the second communication device in a long-range mode.

10. The method of claim 9, wherein indirect communication between the first communication device and the second communication device in a long-range mode comprises communicating via the one or more other communication devices in ad-hoc fashion.

11. A method of wireless inter-vehicle communication, comprising:
generating, at a first communication device in a first vehicle, a message packet comprising a message and a label indicative of an intended recipient;
storing the message packet in a shared memory location of the first communication device, wherein at least the label indicative of the intended recipient is accessible by one or more other communication devices;
assessing, at a second communication device in a second vehicle and associated with the intended recipient, whether at least a portion of the message packet comprising the label is intended for delivery to at least the second communication device associated with the intended recipient;
assessing, at the second communication device, based at least in part on the label whether at least a portion of the message packet comprising the label is intended for delivery to at least the second communication device associated with the intended recipient;
assessing, at the second communication device associated with the intended recipient, whether or not to receive the message packet; and
receiving, at the second communication device associated with the intended recipient, at least the message of the message packet.

12. The method of claim 11, wherein the label indicative of the intended recipient includes a file path.

13. The method of claim 12, wherein the file path is indicative of the first communication device, the second communication device, and the message.

14. The method of claim 11, wherein the file path comprises an identification of the first communication device, an identification of the second communication device, and a filename associated with the message packet.

15. The method of claim 11, wherein the label indicative of the intended recipient comprises a unique identifier associated with one or more of the intended recipients.

16. The method of claim 15, wherein the label indicative of the intended recipient comprises a license plate number of a vehicle comprising one or more communication devices associated with the sender and one or more intended recipients of the message.

17. The method of claim 11, wherein storing the message packet in a memory location of the first communication device comprises storing the message packet in a shared folder.

18. The method of claim 11, comprising the second communication device associated with the intended recipient querying one or more communication devices to assess that the message packet is intended for delivery to at least the second communication device associated with the intended recipient.

19. The method of claim 11, wherein communication between the first communication device and the second communication device occurs wirelessly and directly between the two devices.

20. The method of claim 11, wherein communication between the first communication device and the second communication device occurs via only communications devices in the network that are substantially similar to the first and second communication devices.

21. The method of claim 11, wherein communication between the first communication device and the second communication device occurs via hopping between one or more communication devices on the network.

22. The method of claim 11, wherein transmission of communication between the first communication device and the second communication device occurs via a Bluetooth protocol.

23. An inter-vehicle communication device, comprising:
a vehicle communication device configured to be located in a vehicle, comprising:
an identification memory location comprising a unique identifier associated with the vehicle;
a shared memory location accessible by other communication devices on an inter-vehicle communication network; and
a wireless communication device configured to exchange data directly with one or more other vehicle communication devices on the inter-vehicle communication network.

24. An inter-vehicle communication system, comprising:
an inter-vehicle communication network, comprising:
a first vehicle communication device located in a first vehicle, comprising:
an identification memory location comprising a first unique identifier associated with the first vehicle; and
a shared memory location wirelessly accessible by one or more second communication devices on the inter-vehicle communication network; and
at least one of the second vehicle communication devices located in a second vehicle.

25. The system of claim 24, wherein at least one of the second vehicle communication devices is located in a second vehicle and is configured to wirelessly access the shared memory location of the first vehicle communication device to assess whether a message packet stored in the shared memory location is intended to be received by the second vehicle communication device.

26. The system of claim 24, wherein the second vehicle communication device is configured to prompt a user as to whether or not the second vehicle communication device should accept a message stored in the shared memory location.
